(19) United States
(12) Patent Application Publication
(10) Pub. No.: US 2008/0127019 A1
(43) Pub. Date: May 29, 2008

(54) METHOD AND SYSTEM FOR DESIGNING A MEMORY REGISTER

(75) Inventors: Niv Amit, Givat Shmuel (IL); Ofer Geva, Ramat HaSaron (IL); Lidor Goren, Netanya (IL); Alon Margalit, Ranana (IL); Robert Alan Philhower, Valley Cottage, NY (US); Alex Raphayevich, Kiryat Ekron (IL); Amir Turi, Ramat Gan (IL)

Correspondence Address: INTERNATIONAL BUSINESS MACHINES CORPORATION;DEPT. 18G, BLDG. 300-482, 2070 ROUTE 52, HOPEWELL JUNCTION, NY, 12533, US

(73) Assignee: INTERNATIONAL BUSINESS MACHINES CORPORATION, Armonk, NY (US)

(21) Appl. No.: 11/555,747

(22) Filed: Nov. 2, 2006

(51) Int. Cl. G06F 17/50

(52) U.S. Cl. 716/10

(57) ABSTRACT

Disclosed is a system and method for designing a register layout. According to some embodiments of the present invention, a technology specification is combined with project specifications to produce a set of project specific layout constraints. The project specific constraints may be used to produce a layout.

### FIELD OF THE INVENTION

The present invention generally relates to the field of integrated circuit design. More specifically, the present invention relates to system and method for at least partially automating the process of designing and laying-out custom memory registers.

### BACKGROUND

Early generations of electronic computing devices (e.g. computers) were based on vacuum tubes. Later, vacuum tubes were replaced by semiconductor devices, where the first discrete semiconductor devices had one transistor on each device substrate. Subsequent advances in semiconductor fabrication technology made it possible to put more than one transistor on a single substrate, in the form of an integrated circuit (IC). As a consequence of this integration, more and more individual functions and complex systems were made possible.

The first Small-Scale-Integration (SSI) IC's had very small numbers of devices on a single chip—diodes, transistors, resistors and capacitors (without any inductors), making it possible to fabricate one or more logic gates on a signal device. Further generations of computing devices utilized Large-Scale Integration (LSI), IC's with at least a thousand logic gates on a single IC.

The natural successor to LSI based computing devices were Very-Large-Scale-Integration (VLSI—many tens of thousands of gates on a single chip) based computing devices. Current IC fabrication technology has moved far past this mark, and today's microprocessors have many millions of gates and hundreds of millions of individual transistors. Accordingly, the design process for VLSI circuits has evolved from a relatively simple process, where relatively few circuits were initially placed onto a circuit layout, to modern complex integrated circuits, where computer aided design (CAD) tools are used to realize a circuit layout.

Today's VLSI circuits are generally comprised of many different synchronous circuits. A synchronous circuit is characterized as being comprised of memory devices interwoven between elements of logic devices. Such memory devices are usually referred to as latch points, or when referring to sets of multiple memory devices, registers. Registers are synchronous components and their activity is usually coordinated by a global “clock” signal that permeates through the entire circuit or through a portion of the circuit.

A full custom design methodology of an integrated VLSI circuit refers the creation of an integrated circuit that is highly optimized usually for speed, power or area (when compared to standard cell design). Furthermore, a full custom circuit is usually comprised of numerous types of registers with different specifications.

According to the current state of the art, the steps of producing a full custom memory register layout include:

I. Determining the register memory size (e.g. amount of data bits).

II. Determining the register's output diving power (i.e. maximum current at output).

III. Determining the LCB (Local Clock Buffer) of the register.

IV. Defining various characteristics, such as testability and physical geometry.

V. Manually creating the complete logical and electrical design of the circuit.

The existing methodology for creating full custom registers requires the designer to manually perform the steps described above, while taking into account all of the specifications the register being created has to comply with. Once a full custom register is created, it can be added to a library of registers that other designers can benefit from (i.e. use already made registers from the library). But even if a large library of registers is complied, it will rarely encompass the entire range of possible custom register specifications for a project. Thus, every small deviation in the specifications of an existing library register requires the creation of a new custom register design.

The information used for the design of a full custom memory register can be divided to three different categories:

I. Technology specifications—this group consists of data element such as transistor sizes and characteristics, metal interconnect rules and manufacturing grids.

II. Project methodology specifications—this group consists of data element such as maximum number of bits per register, standard register layout topologies, logical and electrical effort calculation methodology and “clock” signal distribution methodology.

III. Custom specifications—this group refers to the specific requirements a designer has in regard to the register he/she wishes to create and consists of data elements such as: number of data bits, clock bay location and size, latch type of the register (e.g. Master-Slave, Edge-triggered, Level Sensitive), signal driving strength, polarity (e.g, input inverted, output inverted), power supply location, LCB (local clock buffer size), structure of “clock” signal and the “clock” signal capacitance load, testability options (e.g. scan chain, scan direction, abist) and data flow direction in the layout.

The creation and integration of a full custom register design within the general circuit design is a major time consuming phase of the overall process. There is a need for an improved method and system for the design of custom registers.

### SUMMARY OF THE INVENTION

There is provided, in accordance with some embodiments of the present invention, a method and system for automating the design of a memory register. An initial step for creating and designing a memory register is to input or otherwise store project and technology specification data associated with the register in a computer based system according to some embodiments of the present invention. According to yet further embodiments of the present invention, the project and technology specifications data for a given project may be used for the design/creation of substantially all of the memory registers associated with the given project.

According to some embodiments of the present invention, the combination of technology specifications and project specifications may produce a set of project specific layout constraints.

According to some embodiments of the present invention, the generic rules used for the production of a memory register may be computerized and stored in a generic register production rules database.

According to some embodiments of the present invention, the generic register production rules may be adapted according to the project specific layout constraints.

According to some embodiments of the present invention, the adapted generic register production rules may be referred to as tech project specification layout rules.

According to some embodiments of the present invention, the custom specification of the memory register, in combination with the tech project specification layout rules may be accumulated and processed automatically to a full custom layout of the memory register.

According to some further embodiments of the present invention, the project specifications and/or technology specifications may be stored in the system in advance.

According to some embodiments of the present invention, some of the parameters used for the full custom design of a memory register, may be obtained automatically from the custom specification of the register, the register's project specifications and the register's technology specifications.

According to some embodiments of the present invention, the adapted generic rules used for the production of memory register, may be referred to as a set of rules for the design of a fully custom memory register which takes into account the constraints derived from the technology specifications and projects specifications.

According to some further embodiments of the present invention, the output may be a complete physical design of the memory register. According to yet further embodiments of the present invention, the output may be a layout view and or logical schematic view and or symbolic view that depict the integration of the memory register in the integrated circuit.

According to some embodiments of the present invention, the layout of the memory register may be encapsulated in a software code that will be generated in accordance with some embodiments of the present invention. According to yet further embodiments of the present invention, the generated code is reusable and may be used for the creation of more than one register.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings in which:

FIG. 1 is a flowchart illustration of the steps of a method of design/creation of a full custom memory register, in accordance with some embodiments of the present invention;

FIG. 2 is a block diagram depicting an exemplary embodiment of the present invention, in conjunction with the steps of the flow chart in FIG. 1, and in accordance with some embodiments of the present invention;

FIG. 3 is a block diagram depicting the data flow of an exemplary embodiment of the present invention;

FIGS. 4A and 4B depict exemplary layouts of a memory register and clock wiring routing;

FIG. 5 depicts an exemplary embodiment of the system user interface; and

FIG. 6 is a block diagram illustrating an exemplary hardware environment of the present invention.

It will be appreciated that for simplicity and clarity of illustration, elements shown in the figures have not necessarily been drawn to scale. For example, the dimensions of some of the elements may be exaggerated relative to other elements for clarity. Further, where considered appropriated, reference numerals may be repeated among the figures to indicate corresponding or analogous elements.

### DETAILED DESCRIPTION

In the following detailed description, numerous specific details are set for the in order to provide a thorough understanding of the invention. However, it will be understood by those skilled in the art that the present invention may be practiced without these specific details. In other instances, well-known methods, procedures, components and circuits have not been described in detail so as not to obscure the present invention.

Unless specifically stated otherwise, as apparent from the following discussions, it is appreciated that throughout the specification discussions utilizing terms such as “processing”, “computing”, “calculating”, “determining”, or the like, refer to the action and/or processes of a computer or computing system, or similar electronic computing device, that manipulate and/or transform data represented as physical, such as electronic, quantities within the computing system's registers and/or memories into other data similarly represented as physical quantities within the computing system's memories, registers or other such information storage, transmission or display devices.

Embodiments of the present invention may include apparatuses for performing the operations herein. This apparatus may be specially constructed for the desired purposes, or it may comprise a general-purpose computer selectively activated or reconfigured by a computer program stored in the computer. Such a computer program may be stored in a computer readable storage medium, such as, but is not limited to, any type of disk including floppy disks, optical disks, CD-ROMs, magnetic-optical disks, read-only memories (ROMs), random access memories (RAMs) electrically programmable read-only memories (EPROMs), electrically erasable and programmable read only memories (EEPROMs), magnetic or optical cards, or any other type of media suitable for storing electronic instructions, and capable of being coupled to a computer system bus.

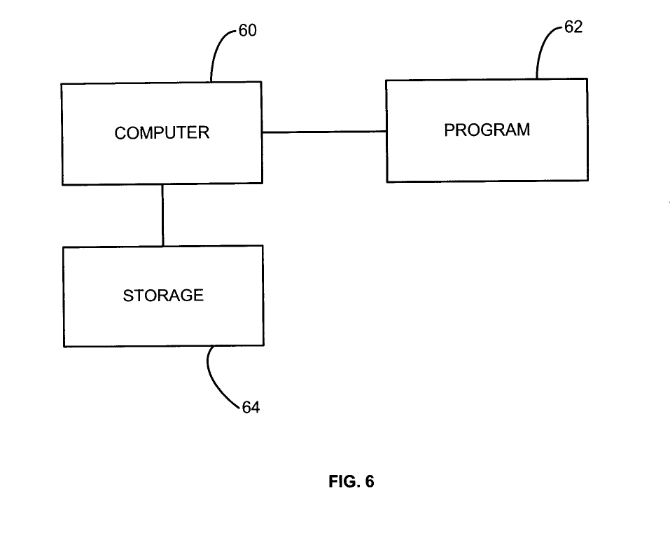

FIG. 6 is a block diagram that illustrates an exemplary hardware environment of the present invention. The present invention is typically implemented suing a computer 60 comprised of microprocessor means, random access memory (RAM), read-only memory (ROM) and other components. The computer may be a personal computer, mainframe computer or other computing device. Resident in the computer 60, or peripheral to it, will be a storage device 64 of some type such as a hard disk drive, floppy disk drive, CD-ROM drive, tape drive or other storage device.

Generally speaking, the software implementation of the present invention, program 62 in FIG. 6, is tangibly embodied in a computer-readable medium such as one of the storage devices 64 mentioned above. The program 62 comprises instructions which, when read and executed by the microprocessor of the computer 60 causes the computer 60 to perform the steps necessary to execute the steps or elements of the present invention.

The processes and displays presented herein are not inherently related to any particular computer or other apparatus. Various general-purpose systems may be used with programs in accordance with the teachings herein, or it may prove convenient to construct a more specialized apparatus to perform the desired method. The desired structures for a variety of these systems will appear from the description below. In addition, embodiments of the present invention are not described with reference to any particular programming language. It will be appreciated that a variety of programming languages may be used to implement the teachings of the inventions as described herein.

There is provided, in accordance with some embodiments of the present invention, a method and system for automating the design of a memory register. An initial step for creating and designing a memory register is to input or otherwise store project and technology specification data associated with the register in a computer based system according to some embodiments of the present invention. According to yet further embodiments of the present invention, the project and technology specifications data for a given project may be used for the design/creation of substantially all of the memory registers associated with the given project.

According to some embodiments of the present invention, the combination of technology specifications and project specifications may produce a set of project specific layout constraints.

According to some embodiments of the present invention, the generic rules used for the production of a memory register may be computerized and stored in a generic register production rules database.

According to some embodiments of the present invention, the generic register production rules may be adapted according to the project specific layout constraints.

According to some embodiments of the present invention, the adapted generic register production rules may be referred to as tech project specification layout rules.

According to some embodiments of the present invention, the custom specification of the memory register, in combination with the tech project specification layout rules may be accumulated and processed automatically to a full custom layout of the memory register.

According to some further embodiments of the present invention, the project specifications and/or technology specifications may be stored in the system in advance.

According to some embodiments of the present invention, some of the parameters used for the full custom design of a memory register, may be obtained automatically from the custom specification of the register, the register's project specifications and the register's technology specifications.

According to some embodiments of the present invention, the adapted generic rules used for the production of memory register, may be referred to as a set of rules for the design of a fully custom memory register which takes into account the constraints derived from the technology specifications and projects specifications.

According to some further embodiments of the present invention, the output may be a complete physical design of the memory register. According to yet further embodiments of the present invention, the output may be a layout view and or logical schematic view and or symbolic view that depict the integration of the memory register in the integrated circuit.

According to some embodiments of the present invention, the layout of the memory register may be encapsulated in a software code that will be generated in accordance with some embodiments of the present invention. According to yet further embodiments of the present invention, the generated code is reusable and may be used for the creation of more than one register.

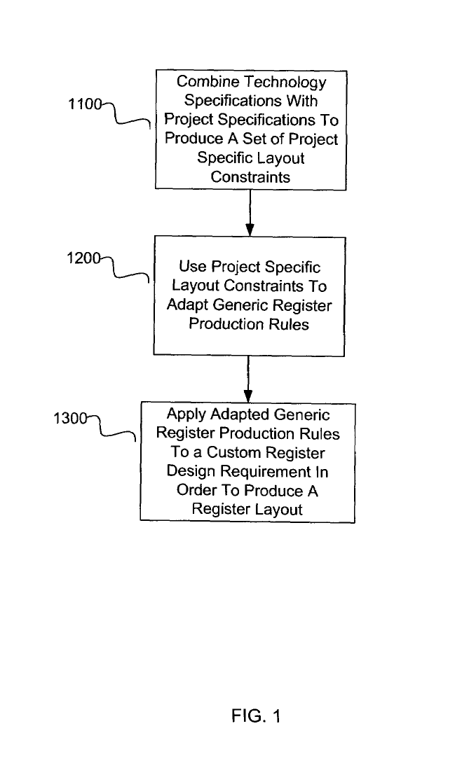

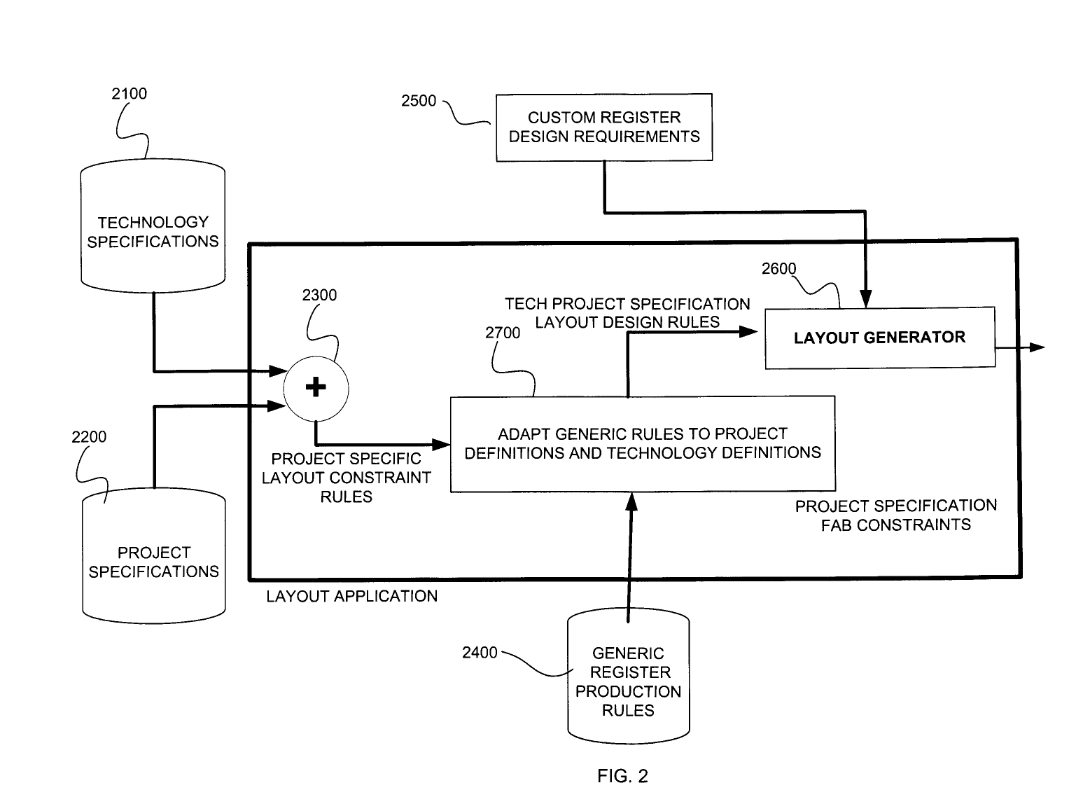

Turning now to FIG. 1, there is shown a flowchart illustration of the steps of a method of designing a full custom memory register, in accordance with some embodiments of the present invention. Turning now to FIG. 2, there is shown a block diagram depicting an exemplary embodiment of the present invention, which embodiments may be described in conjunction with the steps of the flow chart in FIG. 1. A project specific layout constraint module 2300 may derive one or a set of project specific layout constraint rules (step 1100) based on a technology specification stored in database 2100 and a project specification stored in database 2200. According to some embodiments of the present invention, the technology specifications database may include different parameters that are associated with constraints characteristic of the fabrication technology being used for the register. According to some embodiments of the present invention, the project specification database may include different parameters that are associated with constraints characteristic of the specific project (e.g. IC) into which the register is being designed.

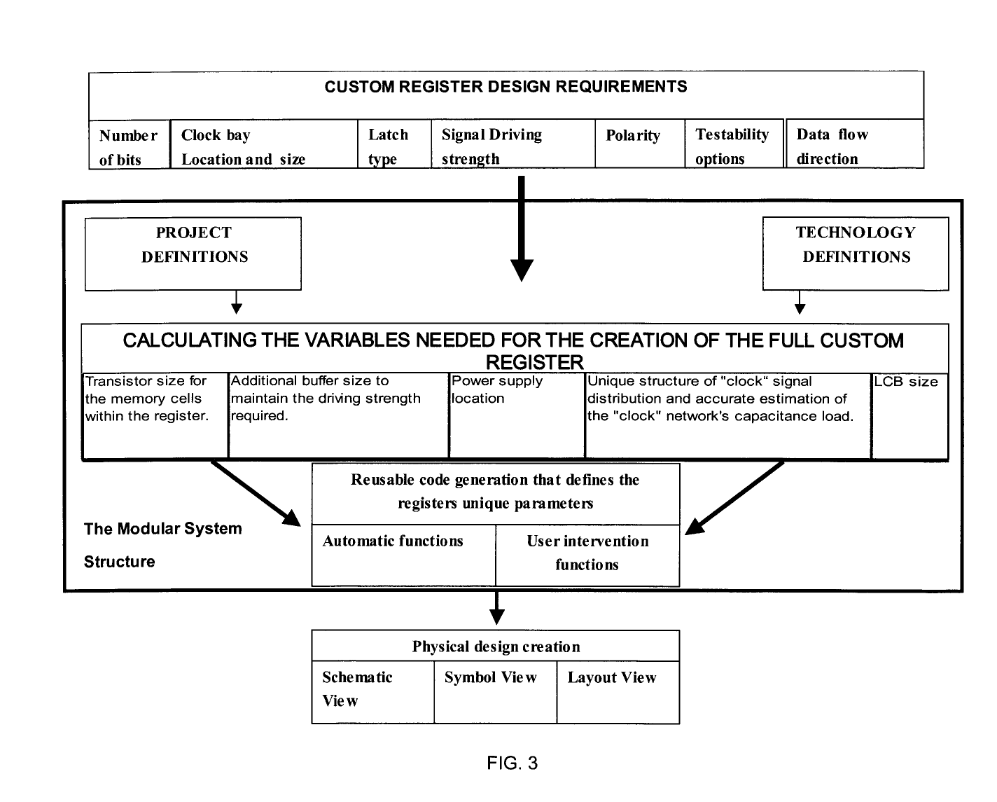

According to some embodiments of the present invention, the project specifications database and the technology specifications database may be populated with parameters such as: transistor sizes and characteristics, metal interconnect rules, manufacturing grids, maximum number of bits per register, standard register layout topologies, logical and electrical effort calculation methodology and “clock” signal distribution methodology. FIG. 3 shows examples of the various parameters which may be associated with each of the specifications or definitions.

Turning now to FIG. 2, referring to the project specific layout constraint module 2300, which corresponds with step 1100 of FIG. 1, where according to some embodiments of the present invention, the technology specifications, which are stored in element 2100, and the project's specifications, which are stored in element 2200, may be combined together and processed to produce a set of project specific layout constraints.

Turning now to FIG. 2, referring to element 2400—a database of generic production rules, where according to some embodiments of the present invention, the generic production rules may include a set of conventions that are used for the production and design of a memory register.

According to some embodiments of the present invention, the database of generic production rules may generate parameters such as: element's size, which is calculated in accordance with the technology specifications, element's location, which is calculated in view of physical constraints (i.e. no two cells are adjacent) and in such a way that will enable an efficient routing methodology.

Turning now to FIG. 2, referring to a rules adaptation module 2700, which corresponds with step 1200 of FIG. 1, where according to some embodiments of the present invention, the generic register production rules, that are stored in element 2400, may be adapted to the project specific layout constraints, which are produced in element 2300. According to some further embodiments of the present invention, this adaptation may produce one or a set of tech project specification layout design rules.

Turning now to FIG. 2, referring to element 2500—a custom register design requirements database, where according to some embodiments of the present invention, the custom register design requirement may consist of specifications and requirement for the design and creation of a specific memory register.

According to some embodiments of the present invention, the custom register design requirements may include parameters such as: number of bits, clock bay location and size, latch type, signal driving strength, polarity, testability options and data flow direction in layout.

Turning now to FIG. 2, referring to element 2600, which corresponds with step 1300 of FIG. 1, where according to some embodiments of the present invention, the layout generator 2600 may apply the adapted generic register production rules, which are generated in element 2700, to the custom register design requirements (element 2500), in order to produce a register layout. The register layout may be in one or more of the forms selected from the group consisting of logical schematic view, symbolic view, and physical layout view. Preferably, the register layout is executable code.

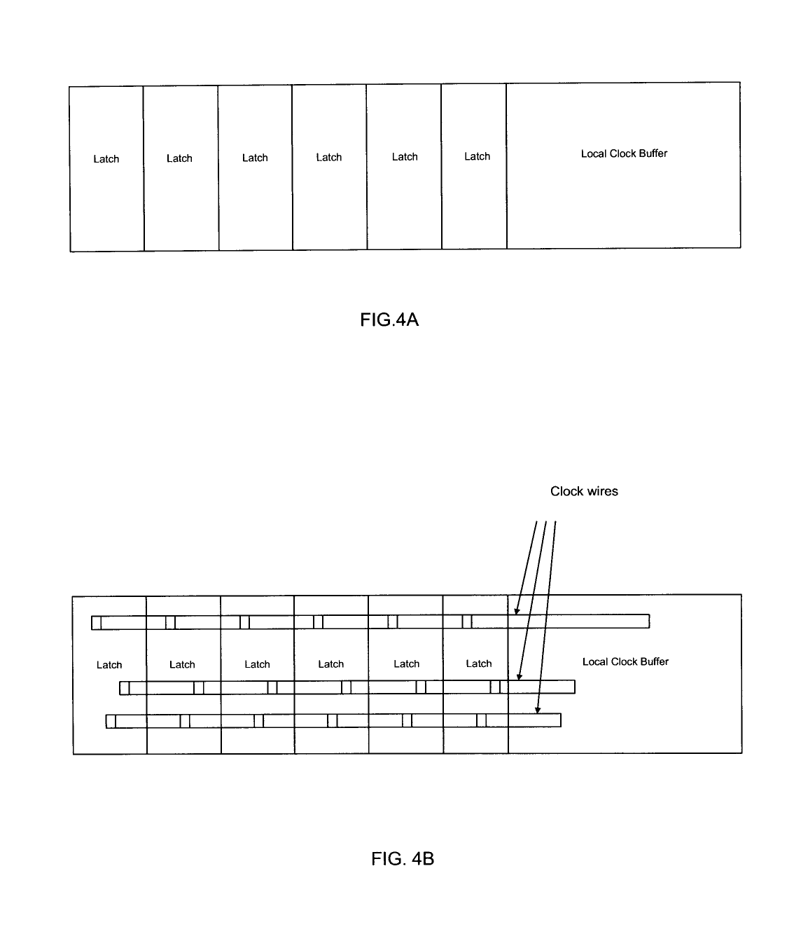

Turning now to FIG. 4A, there is shown an exemplary placement of cells according to the designer's definitions. According to some embodiments of the present invention, the following step after the placement of the cells is clock routing. According to some embodiments of the present invention the clock routing methodology is stored in element 2400 (generic register production rules). In general, clock routing methodology is a set of rules and/or conventions that are used to generate an efficient design for the clock wires electric paths according to predefined parameters.

According to some embodiments of the present invention, an exemplary routing algorithm encapsulates the following steps:

Selecting Wire Parameters—According to the Project and/or Technology Definitions:
1. Wire width;
2. Metal for the wire;
3. Interconnect vias (interconnects in a multi level PCB)—to suite DRC (Design Rule Check) rules.

Selecting Routing Tracks in Accordance with the Following Parameters:
1. Distance from the power grid;
2. Input and output pin location;
3. Examining the presence of shorts and overlaps;

Turning now to FIG. 4B, there is shown an exemplary output of the system after the clock routing was completed.

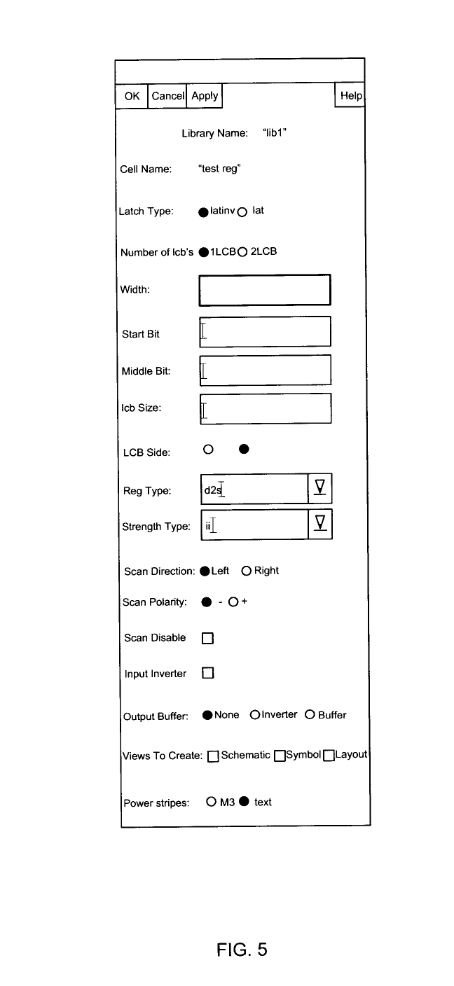

Turning now to FIG. 5, there is shown an exemplary embodiment of the system's user interface. In the suggested embodiment, the user outlines the project's specifications and definitions as explained hereinbefore, and selects the type of output to be generated by the system.

1. A method for creating a customized layout generator to design a layout for integrated circuit (IC) products, comprising:
a) modifying a generic production rule generator by incorporating therein technology specifications;
b) adapting said modified generic production rule generator by incorporating therein project specifications, creating technology and project layout design rules;
c) combining said technology and project layout design rules with custom design requirements, creating said customized layout generator; and
d) creating said layout design for said IC products.

2. The method according to claim 1, further comprising adapting generic register production rules using the project specific layout constraints.

3. The method according to claim 1, further comprising applying adapted generic register production rules to a custom register design requirement to produce a register layout.

4. The method according to claim 1, wherein the project specification includes one or more parameters selected from a group consisting of transistor sizes, transistor characteristics, metal interconnect rules, manufacturing grids, maximum number of bits per register, standard register layout topology, logical and electrical effort calculations, and clock signal distributions.

5. The method according to claim 2, wherein the generic register production rules includes one or more parameters selected from a group consisting of transistor sizes for memory cells within the register, power supply location, local clock buffer size, structure of clock signal, and clock signal capacitance loads.

6. The method according to claim 3, wherein the custom register design requirements includes one or more parameters selected from a group consisting of number of bits, clock bay location and size, latch type, signal driving strength, polarity, testability options and data flow direction in the layout.

7. The method according to claim 3, wherein the register layout is in one or more of forms selected from a group consisting of logical schematic view, symbolic view, and physical layout view.

8. The method according to claim 3, wherein the register layout is represented by executable code.

9. A machine-readable medium having stored thereon data representing sequences of instructions that, when executed by one or more processors, cause the processors to perform operations comprising:
a) modifying a generic production rule generator by incorporating therein technology specifications;
b) adapting said modified generic production rule generator by incorporating therein project specifications, creating technology and project layout design rules;
c) combining said technology and project layout design rules with custom design reciuirements, creating said customized layout generator; and
d) creating said layout design for said IC products.

10. The medium of claim 9, wherein the instructions further cause the one or more processors to adapt generic register production rules using the project specific layout constraints.

11. The medium of claim 9, wherein the instructions further cause the one or more processors to apply the adapted generic register production rules to a custom register design requirement to produce a register layout.

12. A system for creating a customized layout generator to design a layout for integrated circuit (IC) products, comprising:
a) modifying a generic production rule generator by incorporating therein technology specifications;
b) adapting said modified generic production rule generator by incorporating therein project specifications, creating technology and project layout design rules;
c) combining said technology and project layout design rules with custom design requirements, creating said customized layout generator; and
d) creating said layout design for said IC products.

13. The system according to claim 12, further comprising a rules adaptation module for adapting generic register production rules using the project specific layout constraints.

14. The system according to claim 13, further comprising a layout generation module for applying the adapted generic register production rules to a custom register design requirement to produce a register layout.

15. The system according to claim 12, wherein the project specification includes one or more parameters selected from a group consisting of transistor sizes, transistor characteristics, metal interconnect rules, manufacturing grids, maximum number of bits per register, standard register layout topology, logical and electrical effort calculations, and clock signal distributions.

16. The system according to claim 13, wherein the generic register production rules includes one or more parameters selected from group consisting of transistor sizes for the memory cells within the register, power supply location, local clock buffer size, structure of clock signal, and clock signal capacitance loads.

17. The system according to claim 14, wherein the custom register design requirements includes one or more parameters selected from a group consisting of number of bits, clock bay location and size, latch type, signal driving strength, polarity, testability options and data flow direction in the layout.

18. The system according to claim 14, wherein the register layout is in one or more of the forms selected from a group consisting of logical schematic view, symbolic view, and physical layout view.

19. The system according to claim 14, wherein the register layout is represented by executable code.
